(19) United States
(12) Patent Application Publication
(10) Pub. No.: US 2016/0251033 A1
(43) Pub. Date: Sep. 1, 2016

(54) COLLAPSIBLE HOOD INNER STRUCTURE TO ABSORB AND DISSIPATE ENERGY

(71) Applicant: FORD GLOBAL TECHNOLOGIES, LLC, Dearborn, MI (US)

(72) Inventors: Theodore Victor Kolar, JR., Dearborn, MI (US); Sushil Shastry, Swartz Creek, MI (US); Matthew B. Makowski, Northville, MI (US); Aileen M. DeVoe, Royal Oak, MI (US); Se Kyoon Shin, Northville, MI (US); Shawn Michael Morgans, Chelsea, MI (US)

(21) Appl. No.: 14/633,428

(22) Filed: Feb. 27, 2015

(51) Int. Cl. B62D 21/15; B60R 21/38; B62D 65/06; B60R 21/34; B62D 25/12; B62D 27/02

(52) U.S. Cl. CPC B62D 21/15; B62D 25/12; B62D 27/023; B62D 65/06; B60R 21/34; B60R 21/38; B60R 2021/343

(57) ABSTRACT

A hood assembly for a vehicle includes an outer panel and an inner panel. The inner panel includes a plurality of slots or apertures defined in a portion of an edge thereof, disposed to cause a controlled deformation of a left side edge and a right side edge of the hood assembly on receiving a frontal impact. Optionally, at least one lateral crest line may be defined across a width of the inner panel. A hood hinge assembly fixedly attaches the hood assembly to a frame member of the vehicle. In combination, the slots or apertures, optional crest line, and fixed hood hinge assembly reduce rearward displacement of the hood assembly on receiving a frontal impact, thereby reducing damage to vehicle components such as the a-pillar, body side panels, and fenders.

### TECHNICAL FIELD

This disclosure relates generally to energy absorbing/dissipating structures for motor vehicles. More particularly, the disclosure relates to a hood inner panel and assembly incorporating features to absorb/dissipate energy in a collision, and to reduce collision-induced rearward displacement of the hood structure causing damage to other elements of the vehicle.

### BACKGROUND

Modern motor vehicles include a variety of safety features to protect occupants of the vehicle in the event of a collision, including such elements as safety belts, air bags, and bumpers. Other safety features are provided to provide as much protection as possible to a pedestrian in the event of a vehicle-pedestrian low speed collision (for example, less than 15 kph). As is known, such safety features typically include an energy absorber component. Such energy absorber components intended for impact protection in the event of a vehicle-to-pedestrian impact are typically provided as deformable elements, designed to absorb as much impact energy as possible early in the impact to maximize pedestrian protection to the extent possible.

Many jurisdictions now include as part of their safety regulations a requirement that vehicle hood assemblies be constructed to provide protection to the pedestrian in the event of a vehicle-pedestrian collision. However, typically the hood assembly includes at least an outer panel and an inner reinforcing panel to provide structural support for the hood assembly. Thus, in the case of the vehicle hood assembly, this consideration of pedestrian protection must be balanced against the structural requirements imposed on the hood assembly. In other words, a fully deformable hood assembly is not feasible.

The vehicle hood assembly is typically hingedly connected to other elements of the vehicle body and/or frame, such as the A-pillar, to allow access to the engine compartment. Even in a low speed frontal collision the hood assembly is displaced back towards the vehicle passenger cabin. Because the hood is connected to vehicle body and/or frame elements such as the A-pillar, the fenders, and/or the body side panels as the hood assembly is displaced damage to those side elements can occur.

Accordingly, a need is identified in the art for vehicle hood assemblies providing pedestrian protection, but also protection against undue damage to other elements of the vehicle body and frame, for example in the event of a low speed collision.

### SUMMARY

In accordance with the purposes and benefits described herein, in one aspect a hood assembly for a vehicle is described, which provides a controlled buckling pattern to dissipate energy of impact and to reduce rearward translation of the hood assembly in a frontal collision. The hood assembly includes at least an outer panel and an inner panel. The inner panel includes a plurality of slots or apertures defined in a portion of an edge thereof. The hood assembly is attached to a frame member of the vehicle by a hood hinge assembly as is known.

In embodiments, a first set of slots or apertures is disposed at a front right hand corner and a front left hand corner of the inner panel. In other possible embodiments, an additional set of slots or apertures is disposed along the right outer edge and the left outer edge of the inner panel. In yet another possible embodiment, at least one lateral groove is defined in the inner panel to provide at least one crest line in a portion of a width dimension of the inner panel.

In another aspect of the disclosure, a hood hinge assembly is attached at a first end to a portion of the hood assembly and attached at a second, opposed end to a frame member of the vehicle by one or more cooperating conical washers/nuts and serrated-head bolts. In embodiments, cooperating M6 conical washers/nuts and grade 10.9 M8 serrated-head bolts are used.

As will be appreciated, the slots or apertures are disposed to provide a controlled buckling of at least a left side edge and a right side edge of the hood assembly on receiving a frontal impact. The hood hinge assembly provides a fixed point of attachment for the hood assembly. With the optional inclusion of a crest line in the hood inner panel, a hood assembly is provided which deforms in a controlled fashion, dissipating the energy of a frontal impact and also reducing the tendency of the hood assembly to displace rearwardly causing damage to hood-adjacent vehicle elements such as the a-pillar, fender panels, body side panels, etc.

In the following description, there are shown and described several preferred embodiments of the described vehicle hood inner panel and hood assembly. As it should be realized, the hood assembly is capable of other, different embodiments and its several details are capable of modification in various, obvious aspects all without departing from the hood inner panel/hood assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the hood inner panel/hood assembly and together with the description serve to explain certain principles thereof. In the drawing figures:

FIG. 1 depicts an embodiment of a hood inner panel according to the present disclosure;

FIG. 2 depicts an alternative embodiment of the hood inner panel of FIG. 1;

FIG. 3 depicts another alternative embodiment of the hood inner panel of FIG. 1;

FIG. 4 depicts a hood inner panel according to the present disclosure, including a center crest line;

FIG. 5A depicts a serrated-head bolt;

FIG. 5B depicts a conical washer/nut;

FIG. 6 depicts a hood hinge assembly secured to a hood inner panel; and

FIG. 7 depicts the hood hinge assembly of FIG. 6 secured to a vehicle structural member.

Reference will now be made in detail to the present preferred embodiments of the hood inner panel/hood assembly, examples of which are illustrated in the accompanying drawing figures.

### DETAILED DESCRIPTION

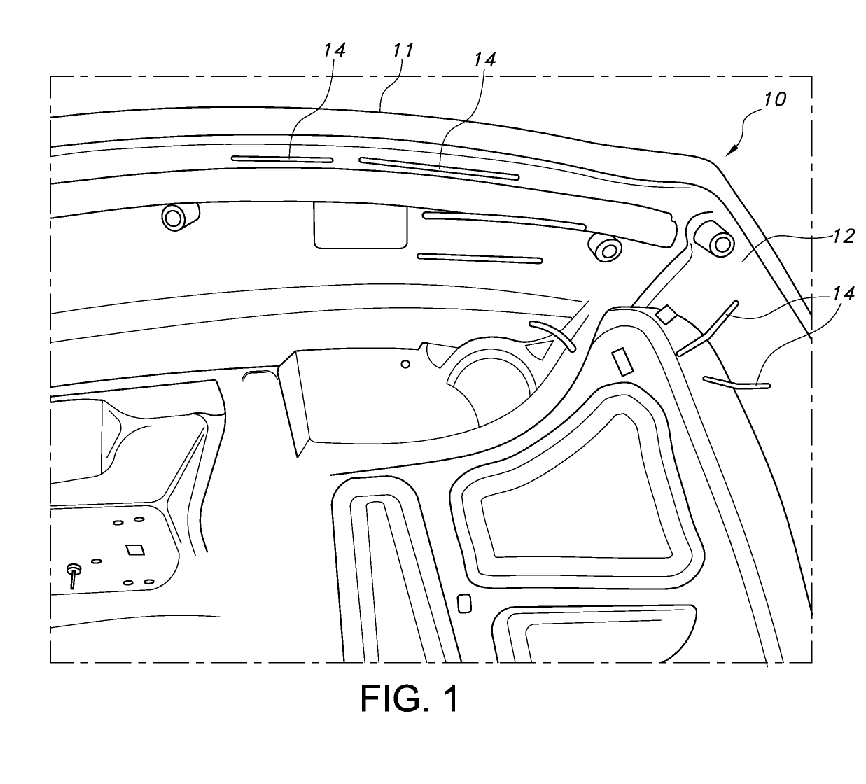

Reference is now made to FIG. 1 illustrating a hood assembly 10 including a hood outer panel 11 and a hood inner panel 12. The hood inner panel 12 includes a plurality of slots or apertures 14 defined in the material thereof. In the embodiment of FIG. 1, a plurality of initiating slots or apertures 14 are provided at a front right hand corner (not shown) and left hand corner 16 of the hood inner panel 12, respectively, the hood inner panel 12 corners 14, 16 being distal to the end of the hood assembly 10 that is attached to the vehicle frame (not shown). As will be described in greater detail below, the slots or apertures 14 provide a structural weakening of the inner panel 12 which, in the event of a frontal impact, will cause a controlled buckling of along a left side edge and a right side edge of the hood assembly 10.

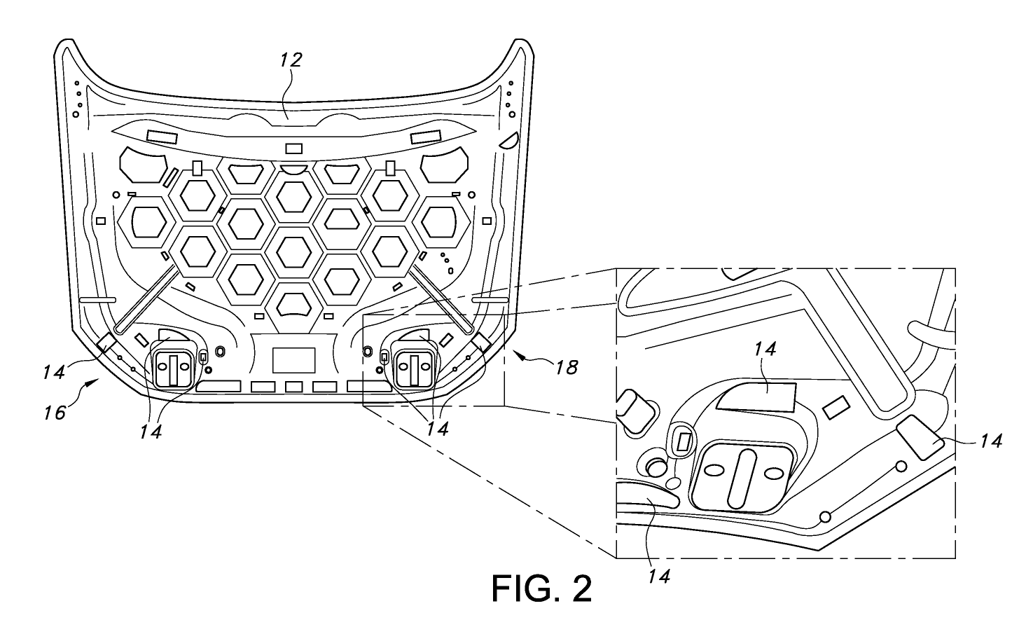

In an alternative embodiment (see FIG. 2), three differently sized/shaped slots or apertures 14 are provided respectively in a front left hand corner 16 and left hand corner 18 of the hood inner panel 12.

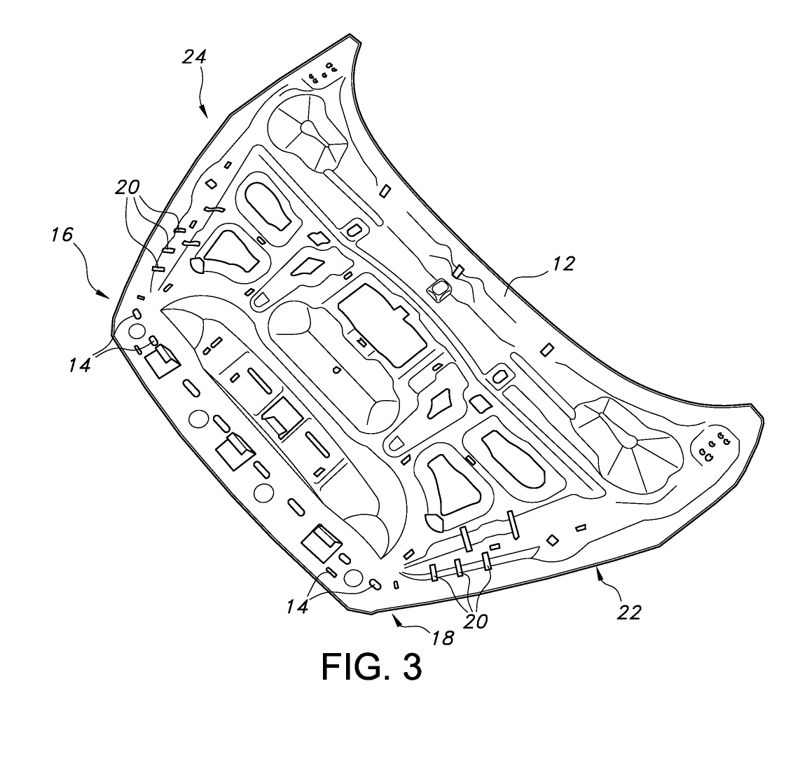

In yet another alternative embodiment (see FIG. 3), a first set of slots or apertures 14 are provided in a front left hand corner 16 and left hand corner 18 of the hood inner panel 12 substantially as described above. Alternatively or in addition, a second set of slots or apertures 20 are provided, respectively defined in the material of the hood inner panel 12 along a left hand side 22 and a right hand side 24.

As will be appreciated by the skilled artisan, the described slots or apertures 14 and/or 20 defined in the material of the front right hand and left hand corners 16, 18 and/or the right hand and left hand sides 22, 24 of the hood inner panel 12 create a slight weakening of the integrity of the panel 12 at those sites, and so in the event of a low speed frontal collision a controlled buckling of the panel 12 will begin at the front right hand and left hand corners 16, 18 and/or along the right hand and left hand sides 22, 24. As the panel 12 buckles along the front right hand and left hand corners 16, 18 and/or the right hand and left hand sides 22, 24, the energy of the impact is absorbed and dissipated, reducing the force of the impact transmitted and also reducing the tendency of the right hand and left hand sides 22, 24 of the hood assembly 10 to displace rearwardly into adjacent elements of the vehicle.

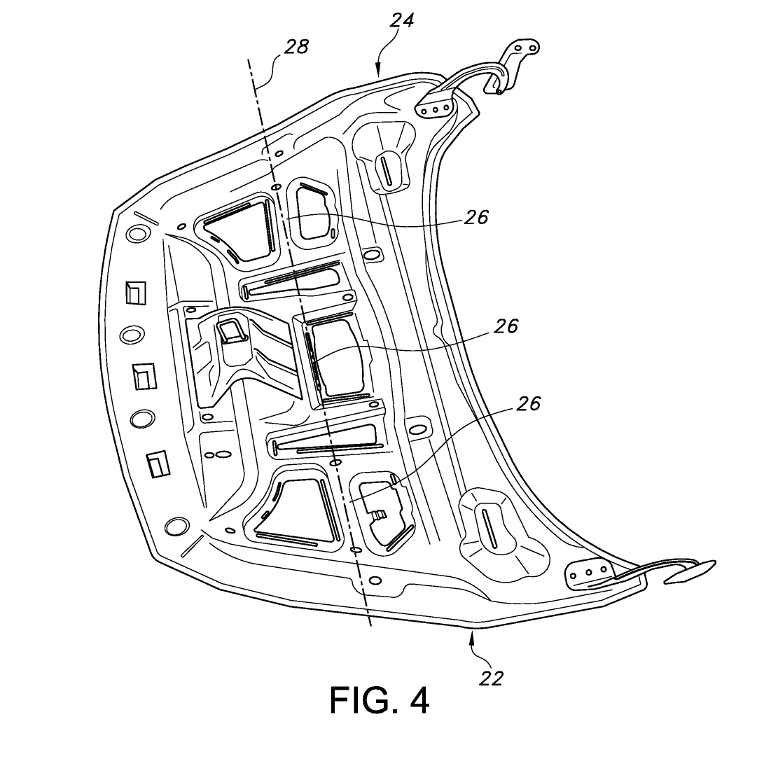

With reference to FIG. 4, one or more lateral grooves 26 may be defined in the material of the hood inner panel 12, in combination defining a crest line 28 laterally extending at least a portion of a width dimension of the panel 12. In the depicted embodiment the crest line 28 extends laterally across a central width dimension of the panel 12. However, as will be appreciated the crest line 28 may be disposed across different portions of the panel 12, or indeed a plurality of crest lines 28 may be defined. Each crest line 28 provides an area that is slightly structurally weaker compared to the remainder of the hood inner panel 12. The crest line 28 will tend to deform more rapidly than the remainder of the structure of the hood inner panel 12, causing the hood assembly 10 to begin to assume an inverted v-shape in the event of a frontal impact. This further reduces rearward displacement of the hood assembly 10 into adjacent vehicle elements after a frontal impact.

The skilled artisan will readily appreciate that by combination of the slots or apertures 14, 20 and the crest line 28, a controlled buckling/folding of the hood assembly 10 is encouraged in the event of a frontal impact. That is, on receiving a frontal impact a conventional hood assembly tends to remain relatively rigid, does not absorb/dissipate energy of impact well, and displaces rearwardly towards adjacent vehicle elements such as the a-pillar, body side panels, and vehicle fenders, causing damage thereto. This does not occur with the presently described hood assembly 10. Instead, a frontal impact will cause the vehicle hood assembly 10 described herein to first buckle in a controlled fashion along the right hand and left hand sides 22, 24 at initiating slots 14, 20 and centrally at the crest line 28, thus reducing rearward displacement.

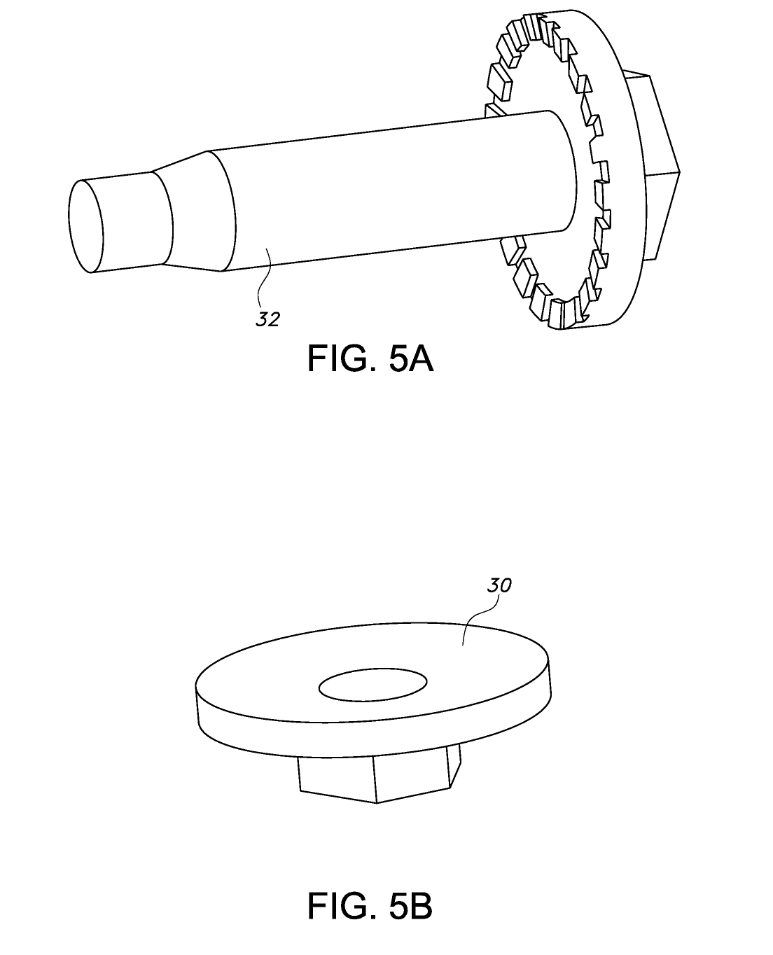

Continuing, a hinge connection is provided between the hood assembly 10 and a frame element of a vehicle to which the hinge is secured that, in combination with the controlled buckling of the hood inner panel 12 described above, minimizes excessive travel of the hood assembly 10 into the vehicle frame element. In an embodiment, a hood hinge assembly is secured to the vehicle frame element by conical washers/nuts 30 and serrated-head bolts 32 (see FIGS. 5A and 5B). As will be appreciated, use of conical washers/nuts 30 and serrated-head bolts 32 increases friction of the mating surfaces, improving clamping load and minimizing slippage of structures secured therewith. In an embodiment, a grade 10.9 M8 (a conventional M8 bolt used to attach a hood to a vehicle is grade 8.8) serrated-head bolt 32 is used in combination with an M6 conical washer/nut 30, increasing the torque applicable thereto from 22 N-m to 30 N-m and so further increasing the clamping load applied to secure the hinge assembly.

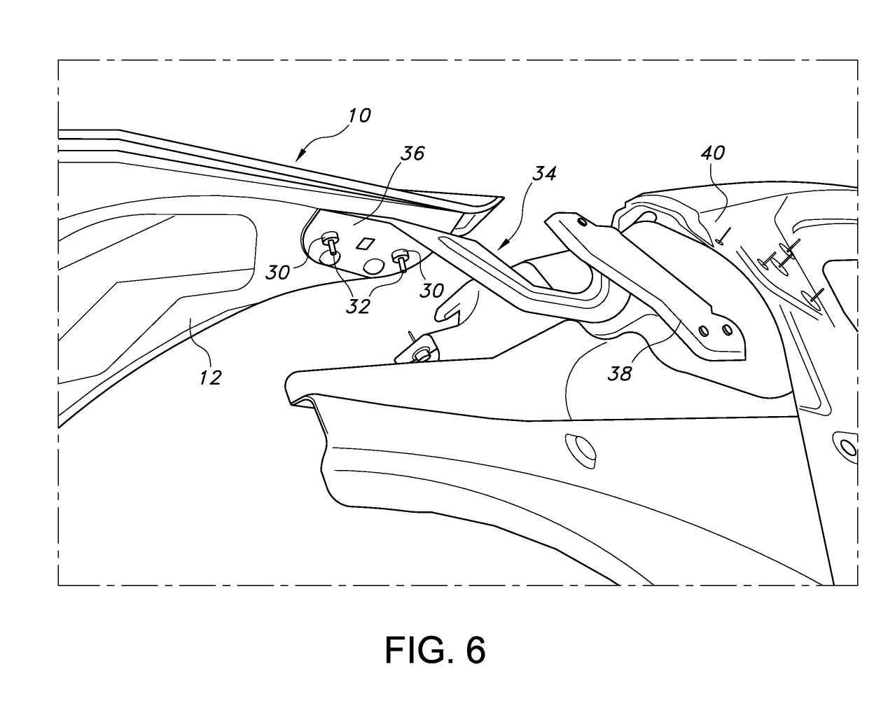

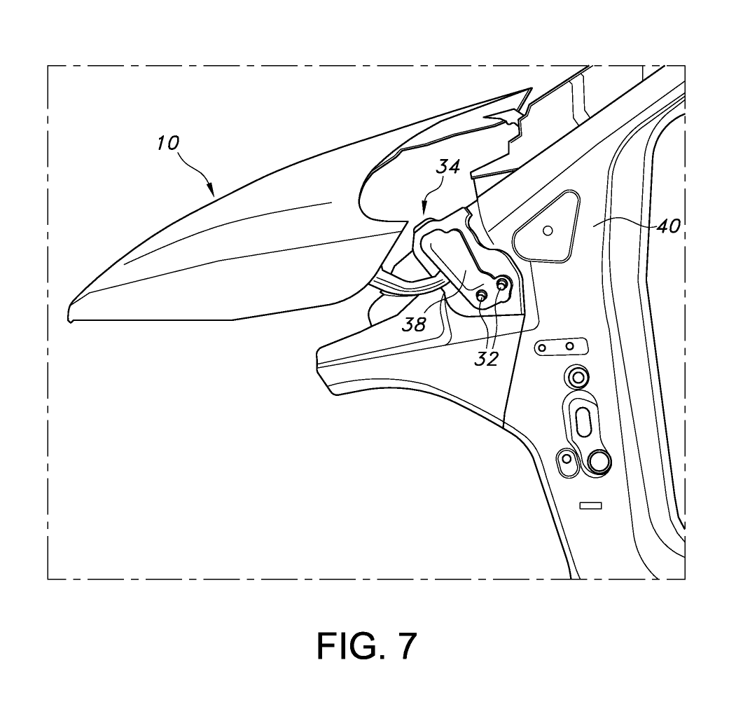

With reference to FIG. 6, a hood hinge assembly 34 is shown by which the hood assembly 10 is secured to a vehicle frame element. The elements of a hood hinge assembly 34 are well known in the art, and do not require exhaustive description herein. Brackets 36, 38 are provided at each end of the hood hinge assembly 30. Bracket 36 attaches to the hood inner panel 12, and bracket 38 attaches adjacent to a vehicle frame element, in the depicted embodiment being the a-pillar 40 (see also FIG. 7). The bracket 32 is attached by conical washers/nuts 30 and serrated-head bolts 32 to the hood assembly 10. In turn, bracket 38 is attached to the a-pillar 40 by serrated-head bolts 32 (see FIG. 6) and conical washers/nuts 30 (not visible in this view).

As will be appreciated, by these attachments in combination with the buckling initiator slots or apertures 14, 20 and crest line 28 as described above, in a frontal collision a controlled buckling of hood assembly 10 is provided that reduces or minimizes the rearward displacement of the hood assembly 10, thus reducing or minimizing damage to hood-adjacent vehicle features such as the a-pillar 40, the vehicle fender (not shown), and the vehicle body side panels (not shown). By the described features, the hood assembly 10 contributes to managing direct impact force of a frontal low speed collision, reducing collateral damage to other elements of the vehicle and so reducing the expense of a collision.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A hood assembly for a vehicle, comprising:
an outer panel;
an inner panel including a plurality of slots or apertures defined at a front right hand corner and a front left hand corner of an edge of the inner panel; and
a hood hinge assembly for attaching to a vehicle frame member;
the slots or apertures and hood hinge assembly in combination creating a controlled deformation of a left side edge and a right side edge of the hood assembly on receiving a frontal impact.

2. (canceled)

3. The hood assembly of claim 1, wherein a second portion of the plurality of slots or apertures is disposed along the right side edge and the left side edge of the inner panel.

4. The hood assembly of claim 1, further including at least one lateral groove defining at least one crest line in a portion of a width dimension of the inner panel.

5. The hood assembly of claim 1, wherein the hood hinge assembly is attached at a first end to a portion of the hood assembly and attached at a second, opposed end to a frame member of the vehicle by one or more cooperating conical washers/nuts and serrated-head bolts.

6. The hood assembly of claim 5, wherein the one or more cooperating conical washers/nuts are M6 washers/nuts and the one or more serrated-head bolts are grade 10.9 M8 bolts.

7. A vehicle including the hood assembly of claim 1.

8. An inner panel for a vehicle hood assembly, including a plurality of slots or apertures at a front right hand corner and a front left hand corner of an edge of the inner panel for encouraging a controlled deformation of a left side edge and a right side edge of the inner panel on receiving a frontal impact.

9. (canceled)

10. The inner panel of claim 8, including a second portion of the plurality of slots or apertures disposed along the right side edge and the left side edge of the inner panel.

11. The inner panel of claim 8, further including at least one lateral groove defining at least one crest line in a portion of a width dimension of the inner panel.

12. A vehicle including the inner panel of claim 8.

13. A method for reducing damage to vehicle elements adjacent to a hood, comprising:
providing a hood assembly for a vehicle having at least an outer panel and an inner panel, the inner panel including a plurality of slots or apertures at a front right hand corner and a front left hand corner of an edge of the inner panel; and
attaching the hood assembly to a vehicle frame member by a hood hinge assembly;
the plurality of slots or apertures and hood hinge assembly in combination creating a controlled deformation of a left side edge and a right side edge of the hood assembly on receiving a frontal impact.

14. (canceled)

15. The method of claim 13, including disposing a second portion of the plurality of slots or apertures along the right outer edge and the left outer edge of the inner panel.

16. The method of claim 13, further including defining at least one lateral groove in the inner panel to provide at least one crest line in a portion of a width dimension of the inner panel.

17. The method of claim 13, further including providing a hood hinge assembly attached at a first end to a portion of the hood assembly and attached at a second, opposed end to a frame member of the vehicle by one or more cooperating conical washers/nuts and serrated-head bolts.

18. The method of claim 17, including fastening the hood hinge assembly at the first end and the second end by one or more cooperating M6 conical washers/nuts and one or more grade 10.9 M8 serrated-head bolts.
